(19) United States
(12) Patent Application Publication
(10) Pub. No.: US 2023/0144230 A1
(43) Pub. Date: May 11, 2023

(54) REHABILITATION SYSTEM BASED ON BRAINWAVE CONTROL

(71) Applicants: Kaohsiung Medical University, Kaohsiung (TW); NATIONAL YANG MING CHIAO TUNG UNIVERSITY, Hsinchu City (TW)

(72) Inventors: Chia-Hsin CHEN, Kaohsiung (TW); Li-Wei KO, Hsinchu City (TW); Yi-Jen CHEN, Kaohsiung (TW); Yi-Chen LU, Hsinchu City (TW); Lo-Fan CHANG, Hsinchu City (TW)

(21) Appl. No.: 17/832,996

(22) Filed: Jun. 6, 2022

(30) Foreign Application Priority Data
Nov. 10, 2021 (TW) 110141879

(51) Int. Cl. A61H 1/02

(52) U.S. Cl. CPC A61H 1/02; A61H 2230/105; A61H 2201/501; A61H 2201/1207

(57) ABSTRACT

A rehabilitation system based on brainwave control includes a rehabilitation device, a brainwave device and a control unit. The rehabilitation device includes a power unit and a rehabilitation unit. The control unit is coupled with the rehabilitation device and the brainwave device. In a state where the power unit provides the predetermined output to control the rehabilitation unit to drive the rehabilitation part to move, the control unit receives the brainwave signal and determines whether the brainwave signal is lower than a stimulation threshold. In a state where the brainwave signal is lower than the stimulation threshold, the control unit sends an adjustment signal to control the power unit to adjust the predetermined output to drive the rehabilitation unit to move.

### CROSS REFERENCE TO RELATED APPLICATION

The application claims the benefit of Taiwan application serial No. 110141879, filed on Nov. 10, 2021, and the entire contents of which are incorporated herein by reference.

### BACKGROUND OF THE INVENTION

### 1. Field of the Invention

The invention generally relates to a rehabilitation system and, more particularly, to a rehabilitation system based on brainwave control.

### 2. Description of the Related Art

As far as conventional rehabilitation methods and systems are concerned, if patients are undergoing rehabilitation, the effectiveness of the rehabilitation effect cannot be immediately and objectively evaluated based on scientific data during the rehabilitation, and the training/stimulation intensity of the target rehabilitation part cannot be immediately adjusted, resulting in poor rehabilitation effect. More specifically, for the patients with stroke, as the neural connection between the rehabilitation part and the brain still has room for improvement, it is difficult for medical or rehabilitation personnel to evaluate the current situation of the patients and the effectiveness of the rehabilitation process without scientific objective quantized data or information-based rehabilitation system. This makes it even more difficult for the patients with stroke to rehabilitate on the rehabilitation part.

In light of the above, it is necessary to improve the conventional rehabilitation system.

### SUMMARY OF THE INVENTION

In order to solve the above problems, it is an objective of the present invention to provide a rehabilitation system which can record and analyze brainwave signals of brain nerve activity in the target rehabilitation part in real-time, so as to evaluate or adjust the effectiveness of rehabilitation to improve the rehabilitation effect.

It is another objective of the present invention to provide a rehabilitation system, which can perform rehabilitation according to the user's will, and can convert the user's will for rehabilitation into corresponding brainwave signals to control the rehabilitation device to perform rehabilitation. In addition to taking care of the user's mental state, the rehabilitation mechanism further forms the controlling intension and real exercise stimulation of rehabilitation into a related brain neural loop to strengthen the rehabilitation effect.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

As used herein, the term “engagement”, “assembly”, or similar terms is used to include separation of connected members without destroying the members after connection or inseparable connection of the members after connection. A person having ordinary skill in the art would be able to select according to desired demands in the material or assembly of the members to be connected.

As used herein, the term “couple” used throughout the invention can mean direct or indirect electrical and/or signal connection, which can be selected by a person having ordinary skill in the art according to the needs thereof.

A rehabilitation system based on brainwave control according to the present invention includes a rehabilitation device, a brainwave device and a control unit. The rehabilitation device includes a power unit and a rehabilitation unit. The power unit is coupled to the rehabilitation unit and is used to provide a predetermined output to drive the rehabilitation unit to move. The rehabilitation unit is used to drive a rehabilitation part of a user to move. The brainwave device includes a plurality of brainwave sensing units each being used to detect a brainwave signal of an active brain area corresponding to the rehabilitation part of the user. The control unit is coupled with the rehabilitation device and the brainwave device. In a state where the power unit provides the predetermined output to control the rehabilitation unit to drive the rehabilitation part to move, the control unit receives the brainwave signal and determines whether the brainwave signal is lower than a stimulation threshold. In a state where the brainwave signal is lower than the stimulation threshold, the control unit sends an adjustment signal to control the power unit to adjust the predetermined output to drive the rehabilitation unit to move.

Accordingly, the rehabilitation device of the present invention determines whether the brainwave signal is lower than a stimulation threshold through the control unit, so as to adjust the predetermined output and generate feedback to the motion state of the user, thereby ensuring that the rehabilitation part can obtain better motion stimulation and improving the efficacy of nerve revitalization and recovery.

In an example, in the state where the power unit provides the predetermined output to drive the rehabilitation unit to drive the rehabilitation part to move, the control unit receives the brainwave signal and determines whether the brainwave signal is greater than a suspension threshold. In a state where the brainwave signal is greater than the suspension threshold, the control unit sends a suspension signal to control the power unit to stop so as to stop the rehabilitation unit. Thus, the rehabilitation part of the user can be prevented from being hurt by pain or overly intensive exercise stimulation, and the safety in rehabilitation can be improved.

In an example, the control unit receives the brainwave signal and determines whether the brainwave signal is lower than an intention threshold. When the rehabilitation unit is in an inactive state and in a state where the brainwave signal is not lower than the intention threshold, the control unit sends a trigger signal to control the power unit to drive the rehabilitation unit to move with the predetermined output. Thus, under the condition that the user has the intention of rehabilitation, the effect of strengthening the connection between the corresponding neurons in the brain can be achieved, and the effect of improving the nerve revitalization and recovery corresponding to the rehabilitation part can also be achieved.

In an example, the control unit receives the brainwave signal and determines whether the brainwave signal is lower than an intention threshold. When the rehabilitation unit is in an active state and in a state where the brainwave signal is lower than the intention threshold, the control unit sends a suspension signal to stop the power unit so as to stop the rehabilitation unit. Thus, the side effects caused by passive or forced rehabilitation can be avoided, providing the user with comfort and sense of reliability. The willingness of long-term rehabilitation of the user can be increased.

In an example, the stimulation threshold is a value of an energy of the brainwave signal measured in dB and ranging from 1.00 dB-10.00 dB. Thus, through the setting of the stimulation threshold, the rehabilitation part of the user can obtain better motion stimulation and improving the efficacy of nerve revitalization and recovery.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a diagram illustrating the scenario of using the system according to a preferred embodiment of the present invention.

FIG. 2 is a diagram illustrating the operations of the system in FIG. 1.

FIG. 3 is a diagram illustrating a brainwave device according to a preferred embodiment of the present invention.

FIG. 4 is a diagram illustrating the brain electrode position according to a preferred embodiment of the present invention.

FIG. 5 illustrates a system block diagram according to a preferred embodiment of the present invention.

In the various figures of the drawings, the same numerals designate the same or similar parts. Furthermore, when the terms “inner”, “outer”, “top”, “bottom”, “front”, “rear” and similar terms are used hereinafter, it should be understood that these terms have reference only to the structure shown in the drawings as it would appear to a person viewing the drawings, and are utilized only to facilitate describing the invention.

### DETAILED DESCRIPTION OF THE INVENTION

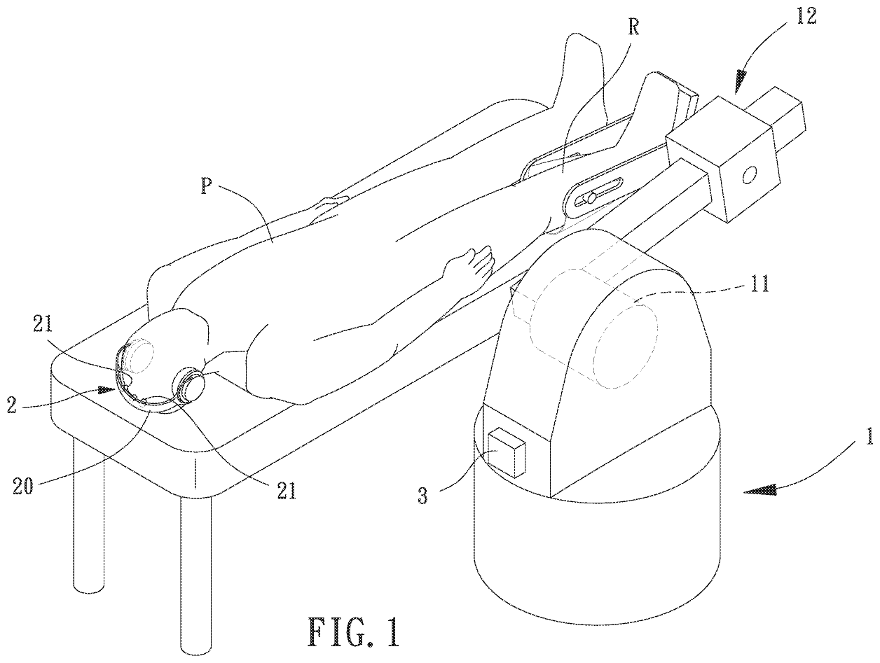

Please refer to FIG. 1, which is a schematic view illustrating the assembled rehabilitation system according to a preferred embodiment of the present invention. The rehabilitation system includes a rehabilitation device 1, a brainwave device 2 and a control unit 3. The control unit 3 is coupled with the rehabilitation device 1 and the brainwave device 2.

The rehabilitation device 1 includes a power unit 11 and a rehabilitation unit 12. The power unit 11 is coupled to the rehabilitation unit 12. The power unit 11 is used to provide a predetermined output to drive the rehabilitation unit 12 to move. The rehabilitation unit 12 can move relative to the rehabilitation device 1 under the drive of the power unit 11, to drive a rehabilitation part R of a user P to move. The power unit 11 may be one or more of a rotary motor, a linear motor, a vibration motor and other power sources, and may include, for example, a utilization of a speed reduction mechanism. The rehabilitation unit 12 may include at least one element/rod or at least one linkage mechanism connected with the power unit to be driven by the power unit 11 to generate a target motion characteristic corresponding to the rehabilitation effect, such as one or more of the trajectory, speed, acceleration, tension, pressure and torque corresponding to the user's target rehabilitation part. It should be understood that the specific configuration of the power unit 11 and the rehabilitation unit 12 can be modified and selected according to the rehabilitation needs. The present invention is not limited in this regard.

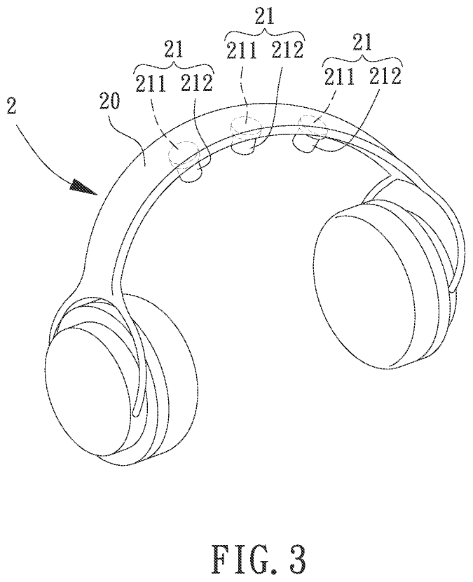

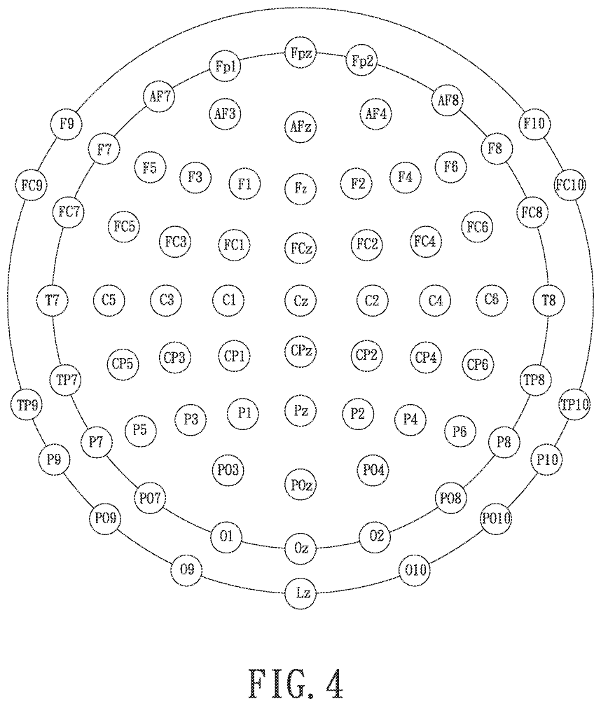

Referring to FIGS. 1-3, the brainwave device 2 has several brainwave sensing units 21, which are used to sense the brainwave signals of an active brain area corresponding to the rehabilitation part R of the user P. The brainwave signals are Electroencephalography (EEG) signals. Preferably, the brainwave device 2 can include a body 20, and the body 20 can include various configurations to facilitate aligning and attaching of the brainwave sensing units 21 to the head of the user P. Each of the brainwave sensing units 21 can include a sensing electrode 211 and a sponge sensing dry electrode 212. One end of the sensing electrode 211 is coupled with the body 20. The sponge sensing dry electrode 212 is coupled with the other end of the sensing electrode 211 for contacting the scalp of the user P. The brainwave sensing units 21 can be detachably combined with the body 20, so as to adjust the number and/or positions of the brainwave sensing units 21 according to the rehabilitation needs. For example, as shown in FIG. 4, the brainwave sensing units 21 can be configured according to the positions of the brainwave electrodes corresponding to the target rehabilitation part. Taking the leg as an example of the target rehabilitation part, the corresponding positions of the brainwave electrodes are distributed at the electrode positions FC1, FCz, FC2, C3, C1, Cz, C2, C4, CP1, CPz and CP2. When the number of the brainwave sensing unit 21 is limited, the brainwave electrodes can be distributed at electrode positions C3, Cz and C4 only.

It should be noted that after the EEG brainwave signal is acquired, it can be processed with a “frequency” approach or a “dB” approach to perform analysis and application. The present invention is not limited in this regard. The so-called “frequency” approach mainly refers to the calculation of correlation algorithm for detecting brain nerve motor function and the judgment of brainwave signal change according to brainwave signals in the range of 1 Hz-30 Hz. Regarding the so-called “dB” approach, one of common practices is to calculate, with an algorithm, the brainwave signal into an energy value in dB. The “brainwave signal” in the present invention includes the original unprocessed brainwave signal and/or the processed brainwave signal.

The control unit 3 can be an element having functions of data processing, signal generation, drive control, data storage, etc. The control unit 3 can be a microcontroller unit (MCU). The control unit 3 is coupled to the rehabilitation device 1 and the brainwave device 2, and is used for receiving the brainwave signals sensed by the brainwave device 2 when the user P uses the rehabilitation device 1, and generating corresponding control signals according to the sensed brainwave signals to adjust the rehabilitation device 1 in real-time. The transmission of brainwave signals, control signals, etc. can be achieved by wireless or wired transmission and reception technologies, or the control unit 3 can be coupled with the rehabilitation device 1 and the brainwave device 2 via a cloud server. The transmission, reception and coupling methods of the present invention are not limited in this regard.

The control unit 3 has a stimulation feedback mechanism. In a state where the power unit 11 provides a predetermined output to drive the rehabilitation unit 12 to drive the rehabilitation part R to move, the control unit 3 receives the brainwave signal and determines whether the brainwave signal is lower than a stimulation threshold. In a state where the brainwave signal is lower than the stimulation threshold, the control unit 3 sends an adjustment signal to control the power unit 11 to adjust the predetermined output to drive the rehabilitation unit 12 to operate. The adjusted predetermined output can replace the predetermined output before adjustment and serve as the current predetermined output, or the iteration and time stamp of these predetermined outputs can be recorded through the control unit 3 or other databases coupled with the control unit 3 to serve as data to be considered or used in rehabilitation management. Through the stimulation feedback mechanism mentioned above, the rehabilitation part R of the user P can get better exercise stimulation, thus improving the effect of nerve revitalization and recovery. For example, when the brainwave signals are converted in dB, the stimulation threshold can be an energy value of the brainwave signal in dB, and the range thereof is preferably 1.00 dB-10.00 dB, with the adjusting interval being 0.01 dB. The stimulation threshold can be set to an appropriate threshold value according to the motor function of the rehabilitation part R of the user P.

The control unit 3 may include a safety stop mechanism. In a state where the power unit 11 provides the predetermined output to drive the rehabilitation unit 12 to drive the rehabilitation part R to move, the control unit 3 receives the brainwave signal and determines whether the brainwave signal is greater than a suspension threshold. In a state where the brainwave signal is greater than the suspension threshold, the control unit 3 sends a suspension signal to control the power unit 11 to stop so as to stop the rehabilitation unit 12. Through the above-mentioned safety stop mechanism, the rehabilitation part R of the user P can prevented from being injured due to pain or overly intensive exercise stimulation. Further, when the brainwave signals are converted in dB, the suspension threshold can be the energy value of the brainwave signal in dB.

The control unit 3 may include an active control mechanism. The control unit 3 receives the brainwave signal and determines whether the brainwave signal is lower than an intention threshold. In a state where the rehabilitation unit 12 remains in an inactive state due to the power unit 11 not providing any output, and the brainwave signal is not lower than the intention threshold, the control unit 3 sends a trigger signal to control the power unit 11 to drive the rehabilitation unit 12 with the predetermined output. In this way, under the situation where the user P has the intention of rehabilitation, the connection between the corresponding neurons in the brain can be strengthened, and the nerve revitalization and recovery effect corresponding to the rehabilitation part R can be thus improved. In addition, in a state where the rehabilitation unit 12 is in an active state and the brainwave signal is lower than the intention threshold, the control unit 12 sends the suspension signal to control the power unit 11 to stop, so as to stop the rehabilitation unit 12. In this way, when the willingness of the user P for rehabilitation is low due to poor physical or mental condition, the side effects caused by passive/forced rehabilitation, such as injury, weakness and discomfort, rejection of rehabilitation, etc., can be avoided. Further, when the brainwave signals are converted in dB, the intention threshold can be the energy value of the brainwave signal in dB, and the intention threshold is smaller than the stimulation threshold.

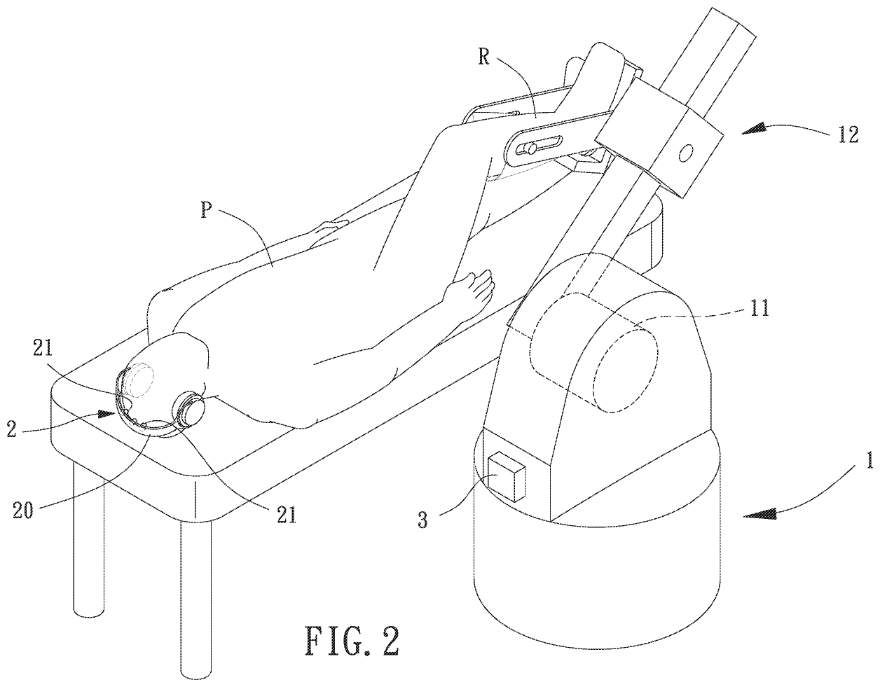

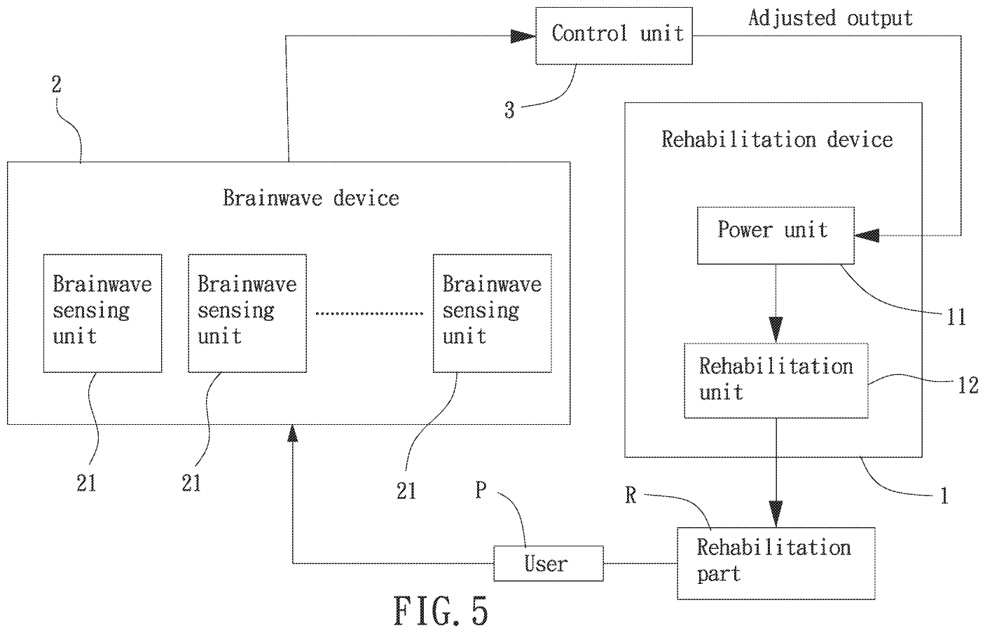

According to the above description, the rehabilitation system based on brainwave control of the present invention may be summarized as the system block diagram shown in FIG. 5. The control unit 3 can analyze and determine the received brainwave signals, and may select from one of a stimulation feedback mechanism, a safety stop mechanism and an active control mechanism according to the analysis and judgment results to send corresponding signals to the power unit 11 to control the operation of the rehabilitation unit 12. In addition, the system architecture proposed by the present invention can be applied to the training of various rehabilitation parts. For example, not only the leg rehabilitation as shown in FIGS. 1 to 2, but also the rehabilitation in hands, tongue or other parts can be carried out. Referring to FIG. 4, if the system architecture is applied to hand rehabilitation, the brainwave sensing unit 21 can be arranged at electrode positions FC3, FC1, FCz, FC2, FC4, C3, C1, Cz, C2, C4, CP3, CP1, CPz, CP2 and CP4, etc. If it is applied to tongue rehabilitation, the brainwave sensing unit 21 can be arranged at electrode positions FC3, FC4, C5, C3, C4, C6, CPz, CP3 and CP4, etc.

In particular, the setting of thresholds in the present invention (such as the above-mentioned stimulation threshold, suspension threshold and intention threshold) can be automatically determined by a pre-established system/module in a designed/standardized way, and the adjustment or setting of thresholds in the current and/or next rehabilitation can be determined by the user through the brainwave signals detected when using the rehabilitation system of the present invention and the corresponding rehabilitation parts. More particularly, the pre-established system can be trained and established based on deep-learning or big data methods. The big data methods can also include the user's disease information (e.g., the degree, time and location of stroke, etc.) and physiological data (e.g., age, evaluation score of clinical motor function evaluation scale, brainwave signal, etc.). The designed method can obtain the brainwave signal of the user's corresponding rehabilitation parts by using multiple groups of different target motion characteristics/intensities.

The settings of the stimulation threshold, suspension threshold and intention threshold are mainly analyzed and determined according to the brainwave signal with a specific time interval. The unit of measuring the time interval may be millisecond, and, preferably, the appropriate time interval can be500 milliseconds. In an example, the stimulation threshold and the intention threshold are analyzed and determined by the brainwave signals obtained by the user in the exercise state (especially when the rehabilitation system of the present invention is used to rehabilitate the target rehabilitation part). The suspension threshold is analyzed and determined during rehabilitation by the brainwave signal obtained by the user in the static state before exercise or rehabilitation.

According to the above, the rehabilitation system based on brainwave control of the present invention utilizes the stimulation feedback mechanism to obtain better motor stimulation for the rehabilitation part of the user, thus improving the effects of nerve revitalization and recovery. In addition, through the safety stop mechanism, the rehabilitation parts of the user can be prevented from being injured due to pain or overly intensive exercise stimulation. In addition, through active control mechanism, the connection between corresponding neurons in the brain can be strengthened, the effect of nerve revitalization and recovery corresponding to the rehabilitation part can be improved, and the side effects caused by passive or forced rehabilitation can be avoided.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A rehabilitation system based on brainwave control comprising:
a rehabilitation device including a power unit and a rehabilitation unit, wherein the power unit is coupled to the rehabilitation unit and is used to provide a predetermined output to drive the rehabilitation unit to move, and wherein the rehabilitation unit is used to drive a rehabilitation part of a user to move;
a brainwave device including a plurality of brainwave sensing units each being used to detect a brainwave signal of an active brain area corresponding to the rehabilitation part of the user; and
a control unit coupled with the rehabilitation device and the brainwave device;
wherein in a state where the power unit provides the predetermined output to control the rehabilitation unit to drive the rehabilitation part to move, the control unit receives the brainwave signal and determines whether the brainwave signal is lower than a stimulation threshold; and in a state where the brainwave signal is lower than the stimulation threshold, the control unit sends an adjustment signal to control the power unit to adjust the predetermined output to drive the rehabilitation unit to move.

2. The rehabilitation system based on brainwave control as claimed in claim 1, wherein in the state where the power unit provides the predetermined output to drive the rehabilitation unit to drive the rehabilitation part to move, the control unit receives the brainwave signal and determines whether the brainwave signal is greater than a suspension threshold; and in a state where the brainwave signal is greater than the suspension threshold, the control unit sends a suspension signal to stop the power unit so as to stop the rehabilitation unit.

3. The rehabilitation system based on brainwave control as claimed in claim 1, wherein the control unit receives the brainwave signal and determines whether the brainwave signal is lower than an intention threshold; and when the rehabilitation unit is in an inactive state and in a state where the brainwave signal is not lower than the intention threshold, the control unit sends a trigger signal to control the power unit to drive the rehabilitation unit to move with the predetermined output.

4. The rehabilitation system based on brainwave control as claimed in claim 2, wherein the control unit receives the brainwave signal and determines whether the brainwave signal is lower than an intention threshold; and when the rehabilitation unit is in an inactive state and in a state where the brainwave signal is not lower than the intention threshold, the control unit sends a trigger signal to control the power unit to drive the rehabilitation unit to move with the predetermined output.

5. The rehabilitation system based on brainwave control as claimed in claim 1, wherein the control unit receives the brainwave signal and determines whether the brainwave signal is lower than an intention threshold; and when the rehabilitation unit is in an active state and in a state where the brainwave signal is lower than the intention threshold, the control unit sends a suspension signal to stop the power unit so as to stop the rehabilitation unit.

6. The rehabilitation system based on brainwave control as claimed in claim 2, wherein the control unit receives the brainwave signal and determines whether the brainwave signal is lower than an intention threshold; and when the rehabilitation unit is in an active state and in a state where the brainwave signal is lower than the intention threshold, the control unit sends the suspension signal to stop the power unit so as to stop the rehabilitation unit.

7. The rehabilitation system based on brainwave control as claimed in claim 3, wherein when the rehabilitation unit is in an active state and in the state where the brainwave signal is lower than the intention threshold, the control unit sends a suspension signal to stop the power unit so as to stop the rehabilitation unit.

8. The rehabilitation system based on brainwave control as claimed in claim 4, wherein when the rehabilitation unit is in an active state and in the state where the brainwave signal is lower than the intention threshold, the control unit sends the suspension signal to stop the power unit so as to stop the rehabilitation unit.

9. The rehabilitation system based on brainwave control as claimed in claim 1, wherein the stimulation threshold is a value of an energy of the brainwave signal measured in dB and ranging from 1.00 dB-10.00 dB.

10. The rehabilitation system based on brainwave control as claimed in claim 3, wherein the stimulation threshold is a value of an energy of the brainwave signal measured in dB and ranging from 1.00 dB-10.00 dB, and the intention threshold is smaller than the stimulation threshold.

11. The rehabilitation system based on brainwave control as claimed in claim 4, wherein the stimulation threshold is a value of an energy of the brainwave signal measured in dB and ranging from 1.00 dB-10.00 dB, and the intention threshold is smaller than the stimulation threshold.

12. The rehabilitation system based on brainwave control as claimed in claim 5, wherein the stimulation threshold is the value of an energy of the brainwave signal measured in dB and ranging from 1.00 dB-10.00 dB, and the intention threshold is smaller than the stimulation threshold.

13. The rehabilitation system based on brainwave control as claimed in claim 6, wherein the stimulation threshold is the value of an energy of the brainwave signal measured in dB and ranging from 1.00 dB-10.00 dB, and the intention threshold is smaller than the stimulation threshold.
